(19) United States
(12) Patent Application Publication
(10) Pub. No.: US 2010/0202856 A1
(43) Pub. Date: Aug. 12, 2010

(54) ISOLATOR ASSEMBLY AND METHOD OF INSTALLATION

(75) Inventor: Steven P. Donovan, Roscoe, IL (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: ACUMENT INTELLECTUAL PROPERTIES, LLC, Troy, MI (US)

(21) Appl. No.: 12/652,514

(22) Filed: Jan. 5, 2010

Related U.S. Application Data
(60) Provisional application No. 61/152,093, filed on Feb. 12, 2009.

(51) Int. Cl. F16B 43/00

(52) U.S. Cl. 411/546

(57) ABSTRACT

An isolator assembly which may be used, for example, to secure a fuel rail to a cylinder head. The isolator assembly includes a bolt, washer and compressive elements. When using the isolator assembly to mount a fuel rail, preferably initially the washer and a first compressive element are retained on the bolt. A shaft end of the bolt is then inserted into a mounting boss of the fuel rail, and a second compressive element is engaged with both the fuel rail and a threaded portion of the bolt. The bolt is then threaded into the cylinder head, causing the second compressive element to come into contact with the cylinder head and compress, along with the first compressive element. When fully installed, the first compressive element isolates the fuel rail from the bolt itself (and the washer), and the second compressive element isolates the cylinder head from the fuel rail.

### RELATED APPLICATION (PRIORITY CLAIM)

This application claims the benefit of U.S. Provisional Application Ser. No. 61/152,093, filed Feb. 12, 2009, which is hereby incorporated herein by reference in its entirety.

### BACKGROUND

The present invention generally relates to isolator assemblies, and more specifically relates to an isolator assembly for securing a first workpiece to a second workpiece in a manner which isolates the two workpieces.

Depending on the application, sometimes it is beneficial to effectively fasten two workpieces together yet provide isolation between the two workpieces, such as isolation with regard to effects such as vibration or heat. One such application where isolation is desirable is with regard to connecting a fuel rail to an engine. Modern automobile engines function via fuel injection, and fuel injection involves large pressure drops in the fuel injectors. For example, a fuel rail may be subject to a sudden, 25,000 p.s.i. pressure drop when an injector is opened (i.e., to release fuel for combustion). Typically, a mounting boss is provided on the fuel rail, and a bolt extends through the boss and is anchored to the engine head. When an injector opens, the sudden pressure drop causes a vibration force pulse that is transmitted from the injector, through the fuel rail and into the engine head (i.e., via the mounting bosses and bolts which secure the fuel rail to the engine). Subsequently, the vibration can travel in various directions within the engine. This can result in a clicking sound, which may be audible to the occupant(s) of the vehicle. Worse, the vibrations can cause the engine to perform inefficiently or even malfunction.

### OBJECTS AND SUMMARY

An object of an embodiment of the present invention is to provide an isolator assembly which can be used to effectively connect one workpiece to another, and yet provide isolation between the two, such as with regard to vibration and/or heat. Briefly, and in accordance with at least one of the foregoing objects, an embodiment of the present invention provides an isolator assembly which may be used to secure a fuel rail to a cylinder head. The isolator assembly includes a bolt, a washer and a plurality of compressive elements. When using the isolator assembly to mount a fuel rail to a cylinder head, preferably initially the washer and a first compressive element are retained on the bolt. A shaft end of the bolt is then inserted into a mounting boss of the fuel rail, and a second compressive element is engaged with both the fuel rail and a threaded portion of the bolt. At this point, preferably the second compressive element is retained on the bolt viz-a-viz an interference fit with the threaded portion of the bolt, and at least one thread of the bolt extends from the bottom of the second compressive element. The fact that at least one thread of the bolt extends from the bottom of the second compressive element provides that the bolt can be engaged with a threaded bore which is provided on the cylinder head, and threaded into the threaded bore. As the bolt is rotated, causing the bolt to thread into the threaded bore of the cylinder head, the second compressive element comes into contact with the cylinder head and compresses along with the first compressive element. When the bolt is fully rotated to its proper seating torque, the first and second compressive elements of the assembly are preferably compressed to, for example, half their original height. When fully installed, the first compressive element of the assembly effectively isolates the fuel rail from the bolt itself (and the washer), and the second compressive element effectively isolates the cylinder head from the fuel rail.

### BRIEF DESCRIPTION OF THE DRAWING

The organization and manner of the structure and operation of the invention, together with further objects and advantages thereof, may best be understood by reference to the following description, taken in connection with the accompanying drawings, wherein:

FIG. 1 provides a cross-sectional view of an isolator assembly which is in accordance with an embodiment of the present invention, showing a first compressive element and washer being retained on the bolt;

FIG. 2 is similar to FIG. 1, but shows the isolator assembly engaged with a fuel rail;

FIG. 3 is a cross-sectional view of the isolator assembly, showing a bolt of the isolator assembly threadably engaged with a threaded bore which is provided in a cylinder head;

FIG. 4 is similar to FIG. 3, but shows the bolt having been rotated to its proper seating torque, and compressive elements of the assembly having been compressed; and

FIG. 5 provides a cross-sectional view of an isolator assembly which is in accordance with an alternative embodiment of the present invention.

### DESCRIPTION

While the invention may be susceptible to embodiment in different forms, there are shown in the drawings, and herein will be described in detail, specific embodiments of the invention. The present disclosure is to be considered an example of the principles of the invention, and is not intended to limit the invention to that which is illustrated and described herein.

As shown in FIG. 1, an embodiment of the present invention provides an isolator assembly 10 which consists of a bolt 12 having a head portion 14, and a shaft portion 16 which extends from the head portion 14. The shaft portion 16 includes a threaded portion 18, and preferably includes a dog point 20. The shaft portion 16 of the bolt 12 preferably includes an outwardly extending flange 22 as well as a retaining groove 24. Specifically, the bolt may be an M8×1.25 6 g hex flange bolt.

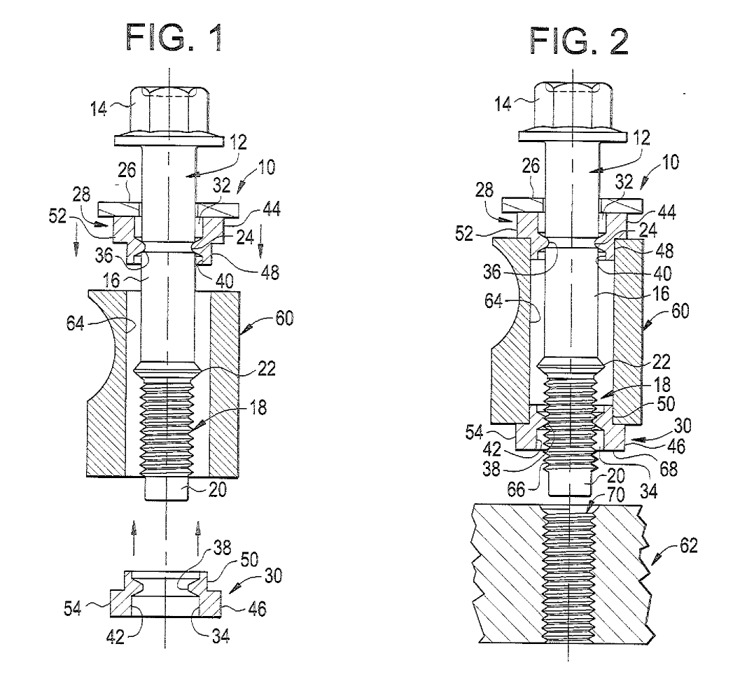

As shown, the isolator assembly also includes a washer 26 (such as a steel washer having a center hole), and two compressive elements 28, 30. Each of the compressive elements 28, 30 may consist of a rubber grommet having a throughbore 32, 34, and an inwardly extending lip 36, 38 on an inner surface 40, 42 thereof. As shown in FIG. 1, preferably the lip 36 in the throughbore 32 of the first compressive element 28 engages the retaining groove 24 on the bolt 12, such that the first compressive element 28 and the washer 26 are effectively retained on the bolt 12 in a pre-assembly. Additionally, as shown in FIG. 2, preferably the lip 38 in the throughbore 34 of the second compressive element 30 engages the threaded portion 18 of the bolt 12 in an interference fit, such that the second compressive element 30 is retained on the bolt 12. As shown in FIGS. 1 and 2, preferably the outer surface 44, 46 of each of the compressive elements 28, 30 has a stepped configuration consisting of a smaller outer diameter portion 48, 50 and a larger outer diameter portion 52, 54.

Installation of the isolator assembly 10 with regard to a fuel rail 60 and a cylinder head 62 will now be described, with the understanding that the isolator assembly 10 could very well be used to secure other types of workpieces together.

As shown in FIG. 1, when using the isolator assembly 10 to mount a fuel rail 60 to a cylinder head 62, preferably initially the washer 26 and the first compressive element 28 are retained on the bolt 12 in a pre-assembly, viz-a-viz engagement of the lip 36 in the throughbore 32 of the first compressive element 28 with the retaining groove 24 on the bolt 12. The shaft portion 16 of the bolt 12 is then inserted into a mounting boss 64 of the fuel rail 60, and the second compressive element 30 is engaged with both the fuel rail 60 and the threaded portion 18 of the bolt 12, thereby providing what is shown in FIG. 2. More specifically, preferably the second compressive element 30 is retained on the bolt 12 viz-a-viz an interference fit between the lip 38 in the throughbore 34 of the second compressive element 30 and the threaded portion 18 of the bolt 12.

As shown in FIG. 2, when the second compressive element 30 is engaged with both the fuel rail 60 and the threaded portion 18 of the bolt 12, at least one thread 66 of the bolt 12 extends from the bottom 68 of the second compressive element 30. The fact that at least one thread 66 of the bolt 12 extends from the bottom 68 of the second compressive element 30 provides that the bolt 12 can be engaged with a threaded bore 70 which is provided on the cylinder head 62, and threaded into the threaded bore 70.

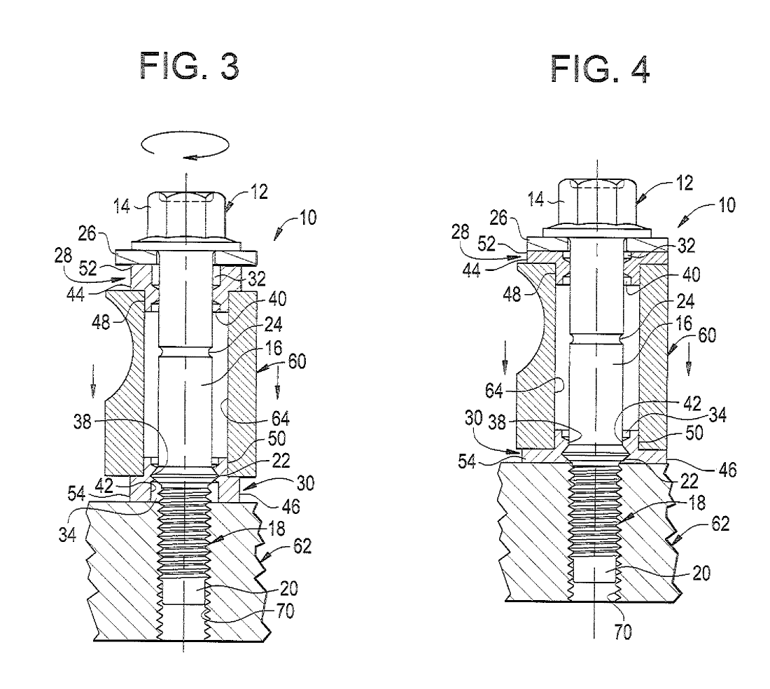

As the bolt 12 is rotated, causing the threaded portion 18 of the bolt 12 to thread into the threaded bore 70 of the cylinder head 62 as shown in FIG. 3, the second compressive element 30 comes into contact with the cylinder head 62 and compresses, along with the first compressive element 28 (i.e., the first compressive element 28 also compresses). Additionally, the outwardly extending flange 22 on the bolt 12 moves past the lip 38 in the throughbore 34 of the second compressive element 30 and becomes seated against the cylinder head 62, thereby preventing further driving of the threaded portion 18 of the bolt 12 into the threaded bore 70 in the cylinder head 62. When the bolt 12 is fully rotated to its proper seating torque as shown in FIG. 4, the first and second compressive elements 28, 30 of the assembly 10 are preferably compressed to, for example, half their original height. When fully installed, the first compressive element 28 of the assembly 10 effectively isolates the fuel rail 60 from the bolt 12 itself (and the washer 26), and the second compressive element 30 effectively isolates the cylinder head 62 from the fuel rail 60.

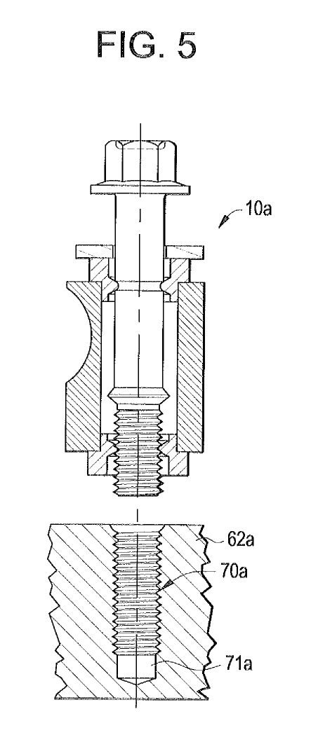

FIG. 5 illustrates an isolator assembly 10a which is in accordance with an alternative embodiment of the present invention. The isolator assembly 10a is very much like the isolator assembly 10 previously described, with the only differences being that the bolt 12a does not have a dog point, and the threaded bore 70a on the cylinder head 62a includes a countersink 71a. The isolator assembly 10a is installed and works the same manner as does the isolator assembly 10.

Still other variations of the isolator are entirely possible. Furthermore, while installation of the isolator assembly with regard to a fuel rail and a cylinder head has been described, an isolator assembly in accordance with the present invention not only can take many forms, but can also very well be used to secure other types of workpieces together besides securing a fuel rail to a cylinder head.

While embodiments of the present invention are shown and described, it is envisioned that those skilled in the art may devise various modifications of the present invention without departing from the spirit and scope of the present disclosure.

What is claimed is:

1. An isolator assembly comprising: a bolt having a head portion and a shaft portion which extends from the head portion, wherein the shaft portion comprises a threaded portion; a washer; a first compressive element which engages the shaft portion of the bolt and retains the washer on the bolt, between the first compressive element and the head portion of the bolt; and a second compressive element which is engageable with the threaded portion of the bolt such that the second compressive element is retained on the bolt.

2. The isolator assembly as recited in claim 1, wherein the bolt comprises a retaining groove, and the first compressive element engages the retaining groove of the bolt such that the first compressive element is retained on the bolt.

3. The isolator assembly as recited in claim 2, wherein the first compressive element comprises an inwardly facing lip which engages the retaining groove on the bolt.

4. The isolator assembly as recited in claim 1, wherein the washer comprises a steel washer having a center hole.

5. The isolator assembly as recited in claim 1, wherein each of the first and second compressive elements comprises a rubber grommet having a throughbore, and an inwardly extending lip on an inner surface thereof.

6. The isolator assembly as recited in claim 5, wherein the bolt comprises a retaining groove, wherein the inwardly extending lip on the inner surface of the first compressive element engages the retaining groove on the bolt, such that the first compressive element and the washer are retained on the bolt.

7. The isolator assembly as recited in claim 6, wherein the inwardly extending lip on the inner surface of the second compressive element engages the threaded portion of the bolt in an interference fit, such that the second compressive element is retained on the bolt.

8. The isolator assembly as recited in claim 7, wherein an outer surface of each of the compressive elements has a stepped configuration comprising a first portion and a second portion, wherein an outer diameter of the first portion is smaller than an outer diameter of the second portion.

9. The isolator assembly as recited in claim 1, wherein the shaft portion of the bolt comprises an outwardly extending flange.

10. The isolator assembly as recited in claim 1, wherein the shaft portion of the bolt comprises an outwardly extending flange which contacts and moves past an inwardly facing lip on the second compressive element during installation.

11. The isolator assembly as recited in claim 1, wherein the bolt has a dog point at its end.

12. The isolator assembly as recited in claim 1, wherein the bolt is threaded to its end.

13. A method of using an isolator assembly to secure a first workpiece to a second workpiece, such that the first workpiece and the second workpiece are secured together but are isolated from each other, said method comprising:
providing an isolator assembly which comprises a bolt, a washer, a first compressive element, and a second compressive element, wherein the bolt comprises a head portion, and a shaft portion which extends from the head portion and comprises a threaded portion;
engaging the first compressive element with the shaft portion of the bolt, such that the first compressive element is retained on the bolt and retains the washer on the bolt, between the first compressive element and the head portion of the bolt;
inserting the shaft portion of the bolt through a boss in the first workpiece;
engaging the second compressive element with both the first workpiece and the threaded portion of the bolt, wherein the second compressive element is retained on the bolt viz-a-viz an interference fit with the threaded portion of the bolt, and the first workpiece is disposed between and in contact with the first compressive element and the second compressive element; and
threading the threaded portion of the bolt into a threaded bore in the second workpiece, thereby causing the second compressive element to come into contact with the second workpiece and causing both the first compressive element and the second compressive element to compress, wherein the first compressive element isolates the first workpiece from the bolt and washer, and the second compressive element isolates the first workpiece from the second workpiece.

14. The method as recited in claim 13, wherein the step of engaging the first compressive element with the bolt comprises engaging an inwardly facing lip on the first compressive element with a retaining groove on the bolt.

15. The method as recited in claim 13, wherein the step of engaging the second compressive element with the threaded portion of the bolt comprises engaging an inwardly facing lip on the second compressive element with the threaded portion of the bolt.

16. The method as recited in claim 13, wherein the step of engaging the first compressive element with the bolt comprises engaging an inwardly facing lip on the first compressive element with a retaining groove on the bolt, and wherein the step of engaging the second compressive element with the threaded portion of the bolt comprises engaging an inwardly facing lip on the second compressive element with the threaded portion of the bolt.

17. The method as recited in claim 13, further comprising providing that an outer surface of each of the first and second compressive elements has a stepped configuration comprising a first portion and a second portion, wherein an outer diameter of the first portion is smaller than an outer diameter of the second portion, further comprising inserting the first portion of each of the first and second compressive elements into the boss in the first workpiece.

18. The method as recited in claim 13, further comprising providing that the shaft portion of the bolt comprises an outwardly extending flange.

19. The method as recited in claim 13, further comprising providing that the shaft portion of the bolt comprises an outwardly extending flange which contacts and moves past an inwardly facing lip on the second compressive element during installation.

20. The method as recited in claim 13, further comprising providing that the shaft portion of the bolt comprises an outwardly extending flange which contacts and moves past an inwardly facing lip on the second compressive element during installation, and engages the second workpiece thereby preventing further rotation of the bolt into the threaded bore in the second workpiece.
